(19) United States
(12) Patent Application Publication
(10) Pub. No.: US 2004/0068984 A1
(43) Pub. Date: Apr. 15, 2004

(54) Dual pump drive system for compact construction vehicles

(76) Inventors: Michael D. Wetzel, Bismarck, ND (US); Jason J. Asche, Gwinner, ND (US)

Correspondence Address: John Veldhuis-Kroeze, WESTMAN CHAMPLIN & KELLY, International Centre - Suite 1600, 900 South Second Avenue, Minneapolis, MN, 55402-3319, US

(21) Appl. No.: 10/270,094

(22) Filed: Oct. 11, 2002

(51) Int. Cl. F16D 31/02

(52) U.S. Cl. 60/486

(57) ABSTRACT

A compact construction vehicle includes a pump drive system including an engine having a flywheel. A first pump assembly is coupled directly to the flywheel such that a rotation rate of the first pump assembly is the same as a rotation rate of the flywheel. A power transfer system is coupled directly to the flywheel and provides a rotation rate which is different than the rotation rate of the flywheel. A second pump assembly is coupled to the power transfer system such that a rotation rate of the second pump assembly is the same as the rotation rate of the power transfer system. One of the first and second pump assemblies provides power for travel of the compact construction vehicle, while the other of the first and second pump assemblies provides power for a work group of the compact construction vehicle.

### BACKGROUND OF THE INVENTION

The present invention relates to compact construction equipment such as mini-excavators. More particularly, the present invention relates to hydraulic systems in compact construction equipment in which an engine drives pumps or pump stacks to power travel of the vehicle and implement work groups.

In hydraulically driven compact construction equipment such as mini-excavators (also known as compact excavators), skid steer loaders, or other work machines, the engine flywheel drives one or more hydraulic pumps or pump stacks for controlling travel of the vehicle, work groups, and engine fans. The hydraulic pumps or pump stacks are typically coupled directly to the engine flywheel using a direct drive coupler. In the alternative, the hydraulic pumps or pump stacks are driven off the engine flywheel using a power transfer system such as a drive pulley rotating at the same rate as the flywheel and a driven pulley rotating at a rate which is determined by the ratio of the drive pulley and the driven pulley. Other power transfer systems could include chain driven devices, sprocket driven devices, and the like. Using these designs, pumps that are directly coupled to the engine flywheel must rotate at the same speed as the engine. In the alternative, if the pumps are driven off the engine flywheel using a power transfer system instead of being directly coupled to the flywheel, the pumps rotate at a fixed multiplier (ratio) of the engine speed.

Since the pumps typically all rotate at the same speed, it is difficult to optimize operation of both vehicle travel components and work group components. Further, having all of the pumps or pump stacks coupled to the flywheel (or in the alternative coupled to the power transfer system in a belt-driven or similar configuration) takes up considerable space in the engine compartment of the construction vehicle. Also, because the rotation rate of some pumps will likely be less than optimum, higher displacement pumps must be used to achieve a particular desired displacement rate, which requires additional space. This in turn limits designers of new types of construction equipment when determining the shape and size of the engine compartment.

Consequently, a compact construction equipment pump drive system which overcomes one or more of the above-described problems in the prior art or other problems not described, would be a significant improvement.

### SUMMARY OF THE INVENTION

A compact construction vehicle includes a pump drive system including an engine having a flywheel. A first pump assembly is coupled directly to the flywheel such that a rotation rate of the first pump assembly is the same as a rotation rate of the flywheel. A power transfer system is coupled directly to the flywheel and provides a rotation rate which is different than the rotation rate of the flywheel. A second pump assembly is coupled to the power transfer system such that a rotation rate of the second pump assembly is the same as the rotation rate of the power transfer system. One of the first and second pump assemblies provides power for travel of the compact construction vehicle, while the other of the first and second pump assemblies provides power for a work group of the compact construction vehicle.

### BRIEF DESCRIPTION OF THE DRAWINGS

FIG. 1 is a perspective view of a machine which utilizes a dual pump drive hydraulic system in accordance with embodiments of the present invention.

FIG. 2 is a first perspective view of the pump drive system in accordance with embodiments of the invention.

FIG. 3 is a top view of the pump drive system shown in FIG. 2.

FIGS. 4 and 5 are second and third perspective views of the pump drive system shown in FIG. 2.

### DETAILED DESCRIPTION OF THE PREFERRED EMBODIMENTS

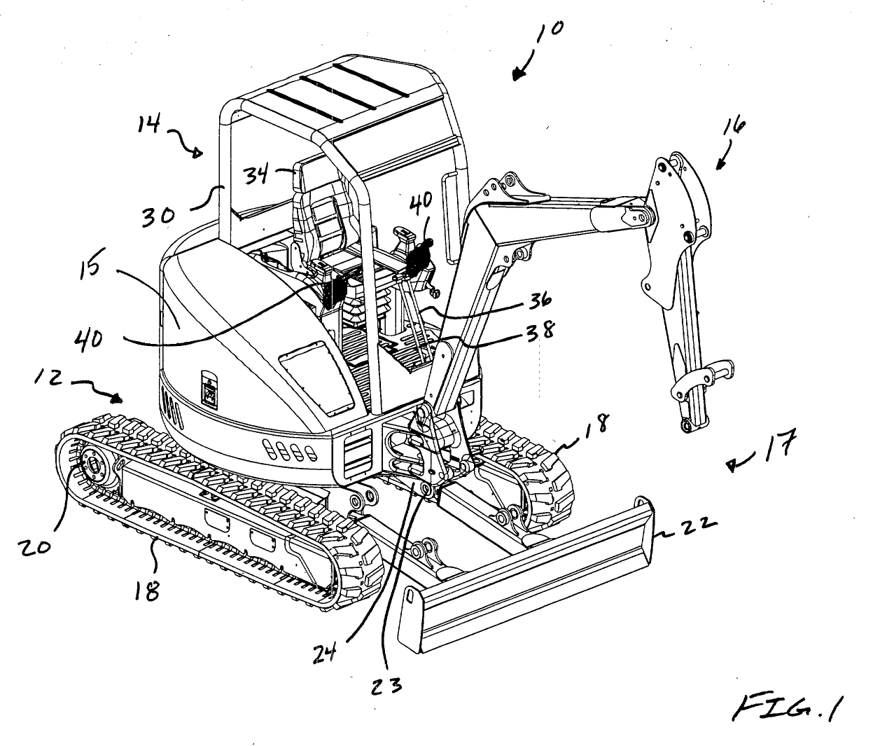

FIG. 1 is a perspective view of a hydraulically driven machine 10 according to the present invention. In the illustrated embodiment, machine 10 is a mini-excavator. However, the present invention is not limited to a particular type of hydraulically driven machine. Instead, the present invention is directed to a dual pump drive which can be used in variety of hydraulically driven compact construction equipment where engine compartment space is limited.

The illustrated mini-excavator embodiment of machine 10 includes a base portion 12, an operator support portion 14, and an implement assembly 16 (such as a dipper assembly or other implement types commonly used with mini-excavators and other machines). The implement assembly represents some or all of a hydraulically driven work group 17. Base 12 includes a pair of tracks 18 on left and right sides of the mini-excavator.

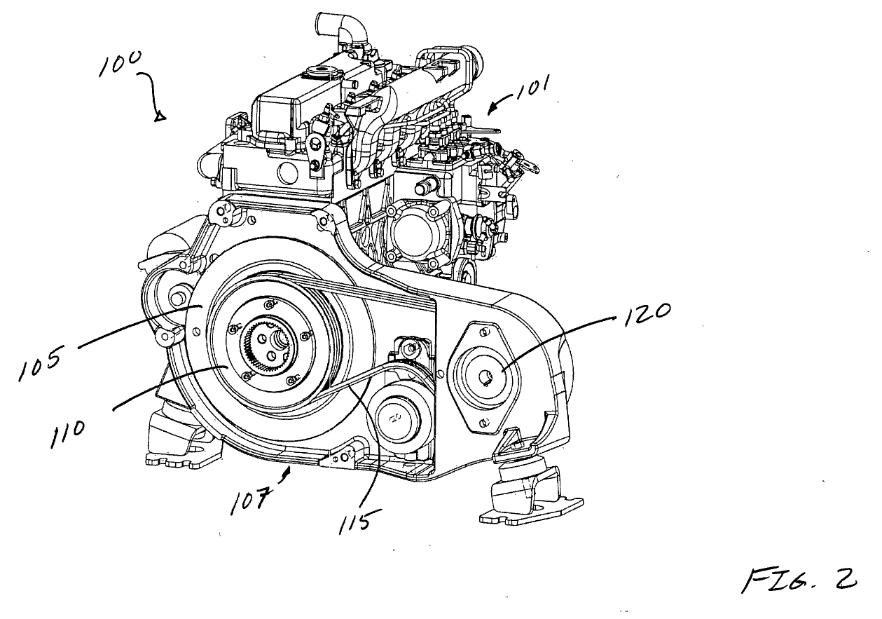

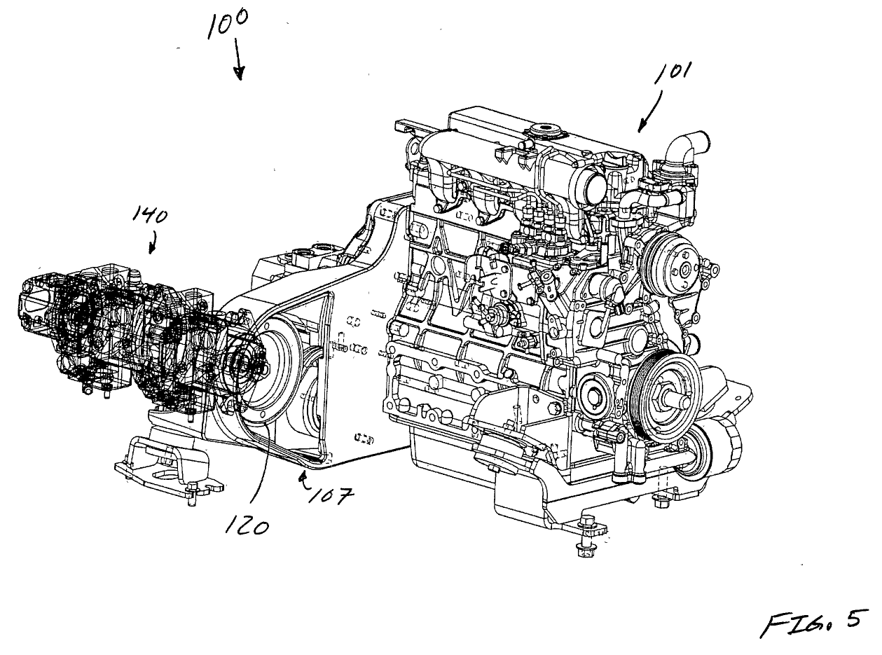

On each of the left and right sides of the mini-excavator, tracks 18 are rotatable about a pair of hubs 20 (only one hub is shown in FIG. 1). On each side of the mini-excavator, at least one of hubs 20 is driven by a hydraulic motor and system which includes, and is controlled by, a travel controller to provide travel. The hydraulic systems are controlled by the operator through manipulation of suitable controls in operator support portion 14. A pump drive system 100 (shown in FIGS. 2-5) is positioned in engine compartment 15.

Base 12 also includes a blade 22 which is pivotally coupled to a frame 24 of the base at a pivot point 23. Hydraulic cylinders (not shown in FIG. 1) are selectively provided with hydraulic fluid under pressure. The operator, upon the manipulation of appropriate controls, can raise and lower blade 22 by controlling the hydraulic power circuit. Blade 22 can also be part of the work group 17.

Operator support 14 is supported by base 12 and includes a canopy or cab 30. Operator support 14 is rotatably coupled to the frame of base 12. While positioned on a seat 34 within canopy or cab 30, the operator can control the travel of the mini-excavator using travel control devices or mechanisms, such as hand controls. In one embodiment, the hand controls include a pair of steering levers 36 and 38, as well as other joysticks 40 or other types of hand controls. Typically, first and second (for example left and right) travel control devices are each mechanically linked or coupled to a travel controller, which controls one or more hydraulic travel systems to drive track assemblies 18 (for example via hubs 20).

Steering levers 36 and 38 (or other travel control devices) are manipulated by the operator to steer the mini-excavator. For example, pushing forward on lever 36 causes the travel controller to the control the hydraulic travel system associated with lever 36 to drive the corresponding left or right track 18 in the forward direction. Pulling back on lever 36 causes the travel controller to control the hydraulic travel system associated with lever 36 to drive the corresponding track 18 in the reverse direction. The relative forward or rearward positions of lever 36 controls the speed of travel of the corresponding track 18 in the forward or reverse directions. The same is true of lever 38 and its associated hydraulic travel system and track 18 which are also under the control of the travel controller. Other joysticks, such as joysticks 40, can be used by the operator to control other hydraulic actuators on the mini-excavator or other machine 10.

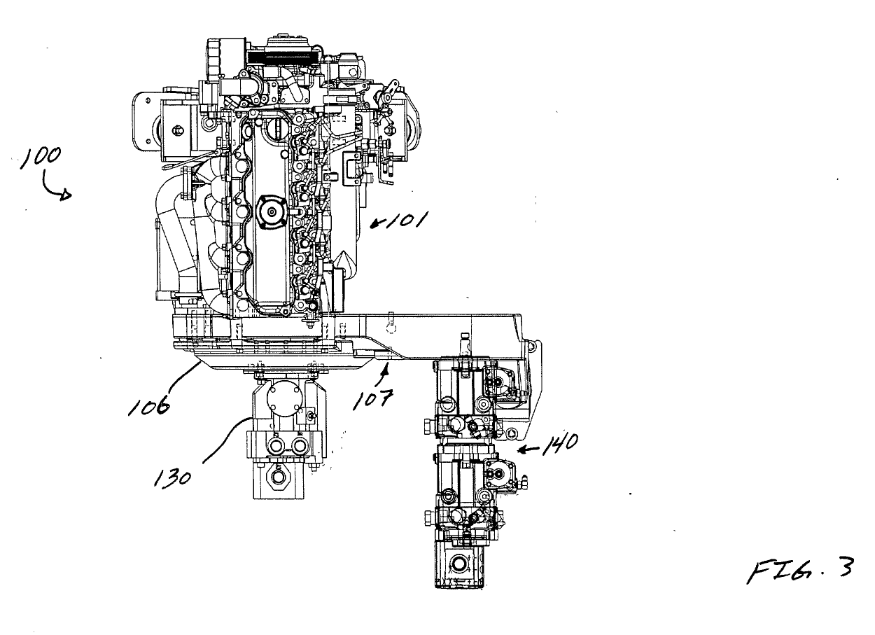

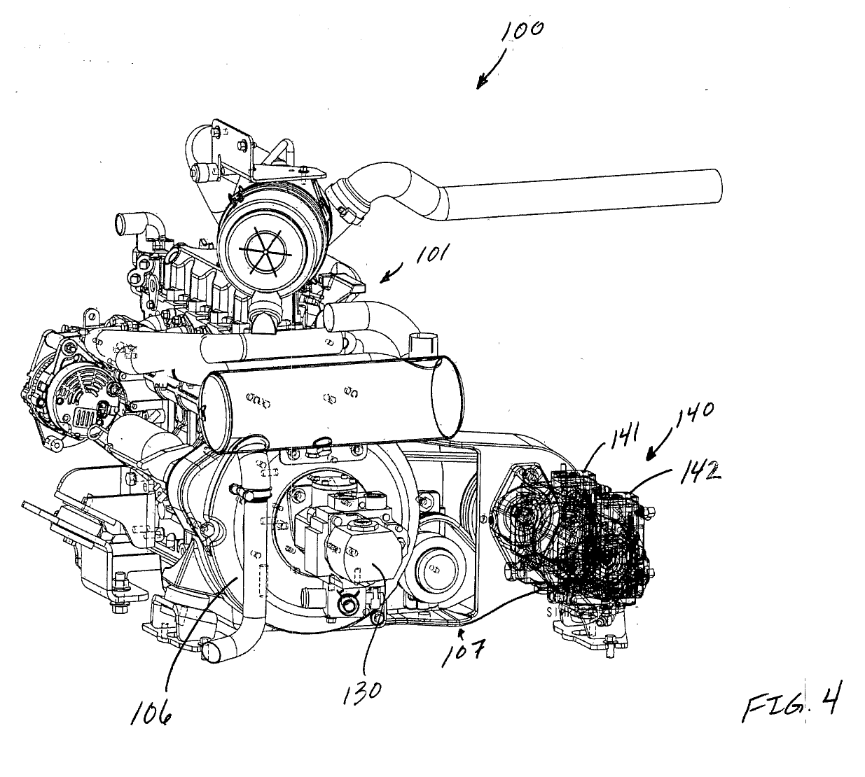

FIGS. 2-4 are perspective and top views of pump drive system 100 positioned within engine compartment 15 (shown in FIG. 1) of mini-excavator 10 in accordance with embodiments of the present invention. As shown in FIG. 2, pump drive system 100 includes an engine 101 having a flywheel 105 positioned under a cover 106 (shown in FIGS. 3 and 4). Flywheel 105 is directly coupled to power transfer system 107. Power transfer system 107 transfers power from the flywheel and provides output power in the form of a rotation rate which is a predetermined multiplier of the rotation rate of the flywheel. In one embodiment, power transfer system 107 includes a drive pulley 110 coupled directly to flywheel 105 such that it rotates at the same rate as the flywheel. Using a flexible mechanical element such as a belt 115 (or rope or chain, for example), rotation of flywheel 105, and thus of drive pulley 110, causes rotation of a pump pulley or driven pulley 120 of the power transfer system 107. The driven pulley provides the power transfer system's rotation rate, which is different than the rotation rate of the flywheel. The diameters of the flywheel pulley or drive pulley 110 and of the driven pulley 120 determine the fixed multiplier ratio at which the driven pulley will rotate relative to the drive pulley. In other embodiments, power transfer system 107 can be other types of flexible power transmission devices or systems. For example, power transfer system 107 can be a belt driven device, a chain driven device, a rope driven device, a sprocket driven device, etc. In each embodiment, the power transfer system converts the rotation rate of the flywheel to a different rotation rate.

In conventional compact construction equipment, the hydraulic pump assemblies used to provide vehicle travel and work group operations have either been directly driven or belt (or other flexible power transmission device) driven, but not both. In other words, the pump assemblies have been either directly coupled to the engine flywheel 105, or have been belt driven using pulleys such as pulleys 110 and 120 (or similar flexible power transmission devices), but not both at the same time.

In accordance with embodiments of the present invention, pump drive system 100 includes a first pump assembly 130 and a second pump assembly 140. Pump assembly 130, which includes one or more pumps or pump stacks, is directly coupled to engine flywheel 105, and thus rotates at the same speed as the engine. Pump assembly 140, which includes one or more pumps or pump stacks, is coupled to power transfer system 107 (to driven pulley 120 in the illustrated embodiment), and thus rotates at the fixed multiplier or ratio of the engine speed. In order to facilitate both the direct pump drive and belt pump drive, engine flywheel 105 is configured to accept a direct drive coupler, and also has grooves for a belt drive.

In one embodiment, pump assembly 130, which rotates at the same speed as the engine, can be used to provide main valve functions. For example, in one embodiment, pump assembly 130 is used to provide power for the work group 17 which can include the blade 22, the implement assembly 16, offset, and other auxiliary functions. In this particular embodiment, pump assembly 140 would then be used to provide power for an engine fan and for travel of the vehicle. As such, pump assembly 140 can include a left hand travel pump 141 and a right hand travel pump 142, both being belt-driven, for driving the left and right tracks of the vehicle. In other embodiments, pump assembly 130 provides power for travel of the vehicle, while pump assembly 140 provides power for the work group 17. An advantage of these configurations of engine 100 is that they provide speed flexibility with regard to the rotational rate of various pumps. During operation, the engine flywheel can drive two different pump assemblies at different speeds at the same time.

The ability to drive the two different pump assemblies, one for travel and one for providing work group power, at different speeds, provides several advantages over the prior art. First, since all of the pumps aren't stacked to all be directly driven off of the engine flywheel or all be belt (or other flexible power transmission device) driven, additional design flexibility is provided. Further, the ability to drive different pump assemblies at different speeds allows the pump assemblies to be optimized for their desired purpose. For example, driving pump assembly 140 used for travel of the mini-excavator at a higher rotation rate allows a smaller (lower displacement volume) pump to be used to achieve some desired displacement rate. In addition to potential cost savings, the smaller pump assembly takes up less room, providing additional design flexibility. Other advantages can also be realized.

Although the present invention has been described with reference to preferred embodiments, workers skilled in the art will recognize that changes may be made in form and detail without departing from the spirit and scope of the invention.

What is claimed is:

1. A pump drive system for a compact construction vehicle, comprising:
an engine having a flywheel;
a first hydraulic pump assembly coupled directly to the flywheel such that a rotation rate of the first pump assembly is the same as a rotation rate of the flywheel;
a power transfer system coupled to the flywheel, the power transfer system providing a rotation rate which is a predetermined multiplier of the rotation rate of the flywheel; and
a second hydraulic pump assembly coupled to the power transfer system such that a rotation rate of the second pump assembly is the same as the rotation rate provided by the power transfer system, wherein a first one of the first and second pump assemblies provides power for travel of the compact construction vehicle and a second one of the first and second pump assemblies provides power for a work group of the compact construction vehicle.

2. The pump drive system of claim 1, wherein the power transfer system comprises a flexible power transmission device.

3. The pump drive system of claim 2, wherein the power transfer system comprises:
a drive pulley coupled directly to the flywheel such that a rotation rate of the drive pulley is the same as the rotation rate of the flywheel; and
a driven pulley coupled to the drive pulley by a drive belt, the driven pulley having a size which is different than the drive pulley such that a rotation rate of the driven pulley is a predetermined multiplier of the rotation rate of the flywheel, the rotation rate of the driven pulley being the rotation rate provided by the power transfer system.

4. The pump drive system of claim 1, wherein the first pump assembly provides power for the work group of the compact construction vehicle.

5. The pump drive system of claim 4, wherein the second pump assembly provides power for travel of the compact construction vehicle.

6. The pump drive system of claim 1, wherein the first pump assembly provides power for travel of the compact construction vehicle.

7. The pump drive system of claim 6, wherein the second pump assembly provides power for the work group of the compact construction vehicle.
